(19) United States
(12) Patent Application Publication
(10) Pub. No.: US 2018/0144874 A1
(43) Pub. Date: May 24, 2018

(54) Tantalum Powder, Anode, And Capacitor Including Same, And Manufacturing Methods Thereof

(71) Applicant: Global Advanced Metals, USA, Inc., Waltham, MA (US)

(72) Inventors: Nick Yin, Waltham, MA (US); Ashish Rai, Waltham, MA (US); Craig Sungail, Waltham, MA (US); Kazunari Yanagiya, Fukushima (JP); Shuhei Yoshikawa, Fukushima (JP)

(73) Assignee: Global Advanced Metals, USA, Inc., Waltham, MA (US)

(21) Appl. No.: 15/299,489

(22) Filed: Oct. 21, 2016

(51) Int. Cl. H01G 9/052; B22F 3/16; B22F 1/00; C25D 9/06; H01G 9/042

(52) U.S. Cl. CPC H01G 9/0525; B22F 3/16; B22F 1/0088; H01G 9/15; B22F 1/0003; H01G 9/042; B22F 2301/20; C25D 9/06

(57) ABSTRACT

A tantalum powder having a value of hydrogen (H) content (ppm) of the tantalum powder divided by Brunauer-Emmett-Teller (BET) surface area (m²/g) of the tantalum powder (H/BET) is greater than 100 is provided. The tantalum powder can be used as an anode of a capacitor, such as a solid electrolytic capacitor, to obtain a capacitor having large capacitance and low current leakage. Methods of producing the tantalum powder, anode, and capacitors including the tantalum powder, also are provided.

### BACKGROUND OF THE INVENTION

The present invention relates to tantalum powder and manufacturing methods thereof. The present invention also relates to an anode, and a capacitor, such as a solid electrolytic capacitor, made with the tantalum powder, and methods for their manufacture.

Tantalum capacitors, made from tantalum powder, have been a major contributor to the miniaturization of electronic circuits. Tantalum powder has been widely used as a source of high capacitance material in the production of electrodes, for example, anodes for solid electrolytic capacitors. These capacitors are used in devices such as smartphones, cell phones, computer tablets, pads and laptops, and other electronic equipment.

Tantalum capacitors, such as electrolytic capacitors, generally have been manufactured by compressing tantalum powder to form a pellet, sintering the pellet to form a porous tantalum body, subjecting the porous body to anodization, infusing a counter electrode material into the sintered porous body, and encapsulating or embedding the device in a non-conductive material.

Tantalum capacitors need to have high capacity per unit volume (volumetric efficiency), a low equivalent series resistance (ESR), a low leakage current, and a high stability towards external stresses. Further improvements in such capacitors continue to be desired in the microelectronics industry.

The electrical properties of a tantalum capacitor can be highly dependent on the characteristics of the starting tantalum powder used to manufacture them. Capacitance and DC leakage of tantalum capacitors, for example, can be related to the specific surface area of the tantalum powder used to form the sintered metal body. Cost and size considerations have dictated that development be focused on means to increase the specific area of the tantalum powder without increasing the usage amount of the material, that is, to increase volumetric efficiency. Capacitance of tantalum powders tends to increase as a function of increasing surface area of the powders. Tantalum powders having smaller (finer) particle size can provide larger surface areas. Previous use of higher surface area tantalum powders, however, has encountered problems.

As explained in U.S. Pat. No. 6,876,542 B2, if the specific surface area of the tantalum powder is increased by using finer powders, then the oxygen content in the powder increases. As a result, a problem arises in that crystalline oxides, which can cause increased leakage current, are more likely to be generated during the heat treatment step or the chemical oxidation step, and also thinning of the dielectric film thickness tends to occur, causing a problem that the long term reliability tends to deteriorate. As a counter-measure to this problem, tantalum powder has been doped during powder production with various types of elements, such as nitrogen, phosphorous, zirconium, titanium, hafnium, carbon, boron, or sulfur, or other elements. U.S. Pat. No. 5,448,447 and WO 01/59166 A1, for example, disclose use of nitrogen doping to reduce the leakage current. These types of dopants typically are retained in the finished sintered powders. The presence of such dopants in the finished powders can lead to problems. If the dopant content in the finished powder is excessive, capacitance or reliability or other performance characteristics may be adversely affected, or other problems may arise.

Another dopant material that has been mentioned for tantalum powders is hydrogen. Tantalum powder after finishing typically contains hydrogen on a level of less than 100 ppm/BET (m²/g) of powder. U.S. Pat. No. 7,729,104 B2 states that these powders can be used for capacitor manufacture, but only under a limit of hydrogen to BET of 100. U.S. Pat. No. 7,729,104 B2 states that a gas-phase hydrogen reduction process of tantalum pentachloride is most preferred as the production process used to make the hydrogen-containing tantalum powder, and that the desired content of hydrogen can be obtained by adjusting the amount of hydrogen in the argon plasma during the gas-phase hydrogen reduction reaction.

Tantalum powders for capacitors also typically are passivated, or acid leached, or both, as part of the production process. Tantalum powders typically are produced by methods which incorporate passivation after deoxidation or other process steps, such as in U.S. Pat. Nos. 7,803,235 and 4,441,927. In passivation, a surface oxide coating is formed to stabilize the powder. Conventional techniques to passivate tantalum particles have involved controlled exposure of the powder to atmospheric air in a gradual or a step-wise increase in pressure. Many passivation cycles, such as 60 cycles or more, may be needed for passivation of a conventional high surface area deoxidized powder. A large number of passivation cycles needed to surface passivate capacitor grade tantalum powders increases production time, costs and complexity. Furthermore, tantalum powders have been acid leached for the removal of the getter material(s) used in an earlier deoxidation step included in the process flow. Some leaching agents can cause powder contamination, such as hydrofluoric acid, or the leaching solutions can cause flaw sites in anodic oxide films of the powder.

Accordingly, a need exists for improvements in doping of tantalum powders, and particularly higher surface area tantalum powders, wherein high capacitance, low leakage current capacitors can be produced using a finished doped powder produced with one or more of reduced process cycles, reduced dopant level retained in the finished powders, reduced acid leach-related flaws in the powders and/or other advantages.

### SUMMARY OF THE PRESENT INVENTION

A feature of the present invention is to provide tantalum powder having high hydrogen (H) to BET ratio values. A further feature is to provide such a tantalum powder which can be used in manufacture of capacitors with low leakage current, even when using high surface area tantalum powders, without impairing other electrical performance or anode or capacitor formation.

A further feature of the present invention is to provide processes for hydrogen doping of tantalum powder.

An additional feature of the present invention is to provide a process for hydrogen doping of tantalum powder, such as deoxidized powder, using hydrogen-containing gas.

Another feature of the present invention is to provide a process for hydrogen doping of tantalum powder which can lead to a reduction in the number of powder passivation cycles typically used to provide passivated capacitor grade powder.

A further feature of the present invention is to provide a process for acid leaching tantalum powder which can provide hydrogen doping and/or more effective hydrogen doping.

Another feature of the present invention is to provide low current leakage anodes formed with hydrogen doped tantalum powder, and/or electrolytic capacitors that include such anodes, and/or methods for making these components.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a tantalum powder comprising tantalum and hydrogen doped therein and nitrogen doped therein, wherein a value of hydrogen (H) content (ppm) of the tantalum powder divided by Brunauer-Emmett-Teller (BET) surface area (m²/g) of the tantalum powder (H/BET) is greater than 100, wherein the tantalum powder has (a) a hydrogen content of from 300 ppm to 1200 ppm, (b) a nitrogen content of from 500 ppm to 3,500 ppm, and (c) a BET range of from 3 m²/g to about 10 m²/g.

The present invention further relates to a sintered pellet comprising the indicated high H/BET tantalum powder, wherein the sintered pellet has a capacitance (CV) of from 150,000 to 500,000 μF-V/g, and a leakage current of 6 nA/μFV or less.

The present invention further relates to an anode for a capacitor comprising the indicated high H/BET (>100) tantalum powder. The present invention also relates to an electrolytic capacitor comprising the indicated anode.

The present invention further relates to a method of making the indicated high H/BET (>100) tantalum powder comprising hydrogen doping tantalum powder to provide hydrogen-doped tantalum powder, and passivating the hydrogen-doped tantalum powder in the presence of gas comprising oxygen to provide passivated hydrogen-doped tantalum powder.

The present invention further relates to a method of making the indicated high H/BET (>100) tantalum powder comprising leaching tantalum powder in an acid leach solution to provide acid leached tantalum powder having a hydrogen doping or level, and washing and drying the acid leached tantalum powder to provide dried tantalum powder with a hydrogen content.

The present invention further relates to a method of making a sintered pellet, comprising the steps of compressing the dried hydrogen-doped tantalum powder made by the indicated method to form a pellet, and sintering the pellet to form a porous body, wherein the porous body has a capacitance (CV) of from 150,000 to 500,000 μF-V/g, and a leakage current of 6 nA/μFV or less, such as 5 nA/μFV or less, or from 0.1 nA/μFV to 6 nA/μFV.

The present invention further relates to a method of making a sintered pellet, comprising the steps of compressing the dried tantalum powder made using the indicated methods to form a pellet, and sintering the pellet to form a porous body, wherein the porous body has at least one of: (i) a capacitance voltage that is at least 5% greater than a capacitance (CV) for a sintered pellet made in the same manner except using 60 cycles of passivation in the passivating and 10% (w/v) hydrogen peroxide in the acid leach solution in the leaching during powder making, (ii) a leakage current (LC) that is at least 5% less than a leakage current for a sintered pellet made in the same manner except using 60 cycles of passivation in the passivating and 10% (w/v) hydrogen peroxide in the acid leach solution in the leaching during powder making.

The present invention further relates to a method of making a capacitor anode, comprising heat treating the porous body made by the indicated method in the presence of a getter material to form an electrode body, and anodizing the electrode body in an electrolyte to form a dielectric oxide film on the electrode body to form a capacitor anode.

It is to be understood that both the foregoing general description and the following detailed description are exemplary and explanatory only and intended to provide a further explanation of the present invention, as claimed.

The accompanying drawings, which are incorporated in and constitute a part of this application, illustrate several embodiments of the present invention and together with the description, serve to explain the principles of the present invention.

### BRIEF DESCRIPTION OF THE DRAWINGS

FIG. 1 is a flow diagram show a process for making high H/BET (>100) tantalum powder, anodes, and capacitors in accordance with an example of the present application.

FIG. 2 is an enlarged schematical representation of a pellet formed with an embedded wire and sintered tantalum powder according in accordance with an example of the present application.

FIG. 3 is an enlarged schematical representation of the structure of a sintered tantalum electrolytic capacitor with solid electrolyte and the cathode contacting layers in accordance with an example of the present application.

FIG. 4 is a flow diagram showing a process for making high H/BET (>100) tantalum powder using hydrogen doping and acid leach in accordance with an example of the present application.

FIG. 5 shows a graph which plots hydrogen doping level with respect to the number of doping cycles in accordance with an example of the present application.

FIG. 6 shows a graph which plots capacitance (CV) with respect to the sintered density (SD) of hydrogen doped powder in accordance with an example of the present application as compared to a reference powder.

FIG. 7 shows a graph which plots testing results for H and H/BET with respect to the number of H-doping cycles in accordance with an example of the present application.

FIG. 8 is a flow diagram showing a process for making increased hydrogen content, high H/BET (>100) tantalum powder using acid leach in accordance with an example of the present application.

### DETAILED DESCRIPTION OF THE PRESENT INVENTION

The present invention relates in part to hydrogen-doped tantalum powders having hydrogen to BET ratio (“H/BET”) values that exceed 100. Anodes can be formed using the high H/BET tantalum powder, which can be incorporated into solid electrolytic capacitors or other capacitors. Even though the high H/BET values (i.e., >100) of the tantalum powders of the present invention are larger than that specified for typical tantalum powders, the tantalum powder can be used in the manufacture of solid electrolyte capacitors having high capacitance, low leakage current, and/or excellent long-term reliability.

As used herein, the H/BET ratio refers to a value obtained by dividing the hydrogen content (ppm) of the tantalum powder by the Brunauer-Emmett-Teller (BET) specific surface area (m²/g) of the tantalum powder. Values of BET specific surface area can be determined by the BET method in accordance with ASTM E1447-09 which is incorporated in its entirety by reference herein. Hydrogen content of the tantalum powder can be determined by a thermal conductivity or infrared detectors or a chemical method. For example, a sample of powder can be heated or melted by heating (e.g., in a resistance heating furnace, a high-frequency induction heating furnace, an impact furnace, or the like) in vacuum or in an inert gas stream, and the contents of emitted hydrogen can be determined by a thermal conductivity analysis method. Alternatively, the hydrogen content in the powder may be determined by a chemical method, such as Kjeldahl method.

The tantalum powder of the present invention can be a hydrogen-containing tantalum powder wherein a value obtained by dividing the hydrogen content (ppm) of the tantalum powder by the specific surface area (m²/g) of the tantalum powder is greater than 100, or from 101 to 300, or from 102 to 200, or from 103 to 150, or from 104 to 140, or from 105 to 135, or from 105 to 130, or from 110 to 135, or from 110 to 130, or from 115 to 135, or from 115 to 130, or from 120 to 135, or from 120 to 130, or from 125 to 250, or from 125 to 135, or other values.

As shown by comparative testing data disclosed herein, capacitor components formed using the indicated high H/BET (>100) tantalum powders of the present invention surprisingly show significant decreases in direct current leakage (DCL), such as over 10% decreases or other reduction levels (e.g., >20% decreases), as compared to capacitor components made using typical finished tantalum powders that have lower hydrogen content with respect to surface area (i.e., H/BET≤100). These improvements in reduced DCL can be obtained using the inventive tantalum powders without the powders showing significant or adverse altered behavior in anode sintering and other electrical performance (other than possible minor inconsequential differences in other gas properties). Further, the present inventors have found that the high H/BET values (>100) can be implemented in large surface area tantalum powders, such as powders having BET surface areas of 3 m²/g or greater, without resulting in any increased leakage current or decreased capacitance of significance in solid electrolytic capacitors formed with them.

Developments have been made in the present invention in powder processing which are associated with producing the indicated high H/BET powders (>100) that impart improved performance in capacitor products made with them. Hydrogen doping processes for tantalum powders have been developed for the present invention which, in one basic approach, dopes hydrogen from a gas into the powder, and in another basic approach, alters the hydrogen level during acid leaching to effectively increase hydrogen dopant in the material from the treatment. These developed processes can use a hydrogen-gas based doping process, such as after deoxidation, or use a cooled/chilled low- or no-oxidizing agent based acid leach solution for acid leaching, or combinations of these, to increase hydrogen content in the tantalum powders. Either one or both of these hydrogen dopant management processes can be used in a process flow used to produce finished tantalum powder of the present invention. The hydrogen doping provided by processes of the present invention has no apparent detrimental effect on powder performance, direct current leakage (DCL) or with respect to wire embrittlement. Any anode shrinkage is within tolerated amounts.

A hydrogen gas-based doping process has been developed for providing high H/BET powders (>100), wherein hydrogen gas-based doping and powder passivation can be sequentially performed on tantalum powder material. The hydrogen-gas based doping of powder need not be performed concurrent with the raw powder production, and instead can be performed as a post-treatment on raw powder or an intermediate powder derived therefrom in the process flow for making finished powder. As shown by comparative testing data disclosed herein, use of the hydrogen gas-based doping treatment on tantalum powders can lead to significant reductions in the number of passivation cycles needed to passivate the tantalum powder, such as reductions in the passivation cycles of 10% or more, or 20% or more, or 30% or more, or 40% or more, or 50% or more, or other reductions. The number of passivation cycles may be reduced to less than 60 cycles, or less than 25 cycles, or less than 10 cycles, or to 5 cycles or less, or other reduced numbers of passivation cycles.

An acid leaching process also has been developed for use in tantalum powder processing of the present invention wherein hydrogen doping, as a hydrogen concentration increase, occurs in the production of high H/BET (>100) tantalum powders when using a cooled/chilled low- or no-oxidizing agent containing acid solution for acid leaching. The oxidizing agent to be minimized or excluded from the acid leaching solution can be hydrogen peroxide or any other peroxide or oxidizing agent. The acid that is used in the acid leaching solution can be a mineral acid, such as nitric acid, sulfuric acid, hydrochloric acid, or any combinations of these or others. Lower temperatures used during acid leaching of the powders can help to increase hydrogen content in the leached powder and the resulting H/BET thereof. It also has been found that the acid leach process can be more effective in these respects when less passivation is used after deoxidation of the powder, such as by using less than 60 cycles of passivation or the other above indicated reduced numbers of passivation cycles. The powder preferably is passivated to such a degree that it is stable in air (no powder burn), and achieve H/BET>100 after acid leach.

The cooled/chilled temperature used in acid leaching can be a temperature of less 70° C. (e.g., powder cooled after being heated in a previous process step), or less than 50° C., or less than 25° C. (e.g., room temperature or from 10° C. to 25° C.), or from 25° C. to 70° C., or from 25° C. to 50° C., or chilled temperatures such as from −5° C. to 10° C. or from −5° C. to −1° C., or other reduced temperatures. Hydrogen content in the powder can be increased with decreased temperature during acid leaching. The tantalum powders treated using such acid leaching solution chemistries in cooled/chilled conditions can achieve increased hydrogen content and H/BET as compared to powders before the acid leach. In addition, there can be a reduced occurrence of flaw sites in an anodic oxide film on the powder, or other benefits.

In processes of the present invention, at least one or both of the indicated hydrogen gas-based doping process and acid leaching process can be used in a process flow for providing hydrogen doping of tantalum powder in the production of high H/BET (>100) powders. The indicated processes of the present invention for hydrogen doping the tantalum powders can be performed without detrimentally affecting other content level (e.g., oxygen content) or surface area of the powders. For example, oxygen content can be maintained or substantially maintained without undesired increases, as hydrogen content is increased by the acid leach process step.

The finished hydrogen-doped tantalum powders having high H/BET (>100) of the present invention can be sintered, such as part of the production of sintered pellets, capacitor anodes, or other components. Hydrogen content of the H-doped tantalum powder of high H/BET (>100) of the present invention can be dissipated during sintering of the powder, such as sintering at 400° C. or higher temperatures. A sintered pellet can be provided that contains reduced hydrogen dopant content as compared to the finished (doped, non-sintered) powder, such as 50% or more reductions (by volume or mass %), without adverse effects on the structure, chemistry or performance of the sintered product. This result can leave less dopant artifacts in the finished products.

Accordingly, the present invention includes methods for hydrogen doping tantalum powder wherein high capacitance, low leakage current capacitors can be produced using hydrogen-doped powder with improvements including one or more of reduced process requirements for powder passivation, reduced acid leach-related damage to the powders, reduced hydrogen dopant retained in the finished powders (e.g., sintered pellets), or other advantages and benefits such as described herein.

When the tantalum powder is used as an anode material of a solid electrolyte capacitor, the tantalum powder is sintered and is then subjected to anodic oxidation to form an oxide film. The sintering can be performed at a temperature of 400° C. or higher. Hydrogen dopant can be dissipated during forming a sintered body with the high H/BET (>100) tantalum powder of the present invention. Even with dissipation of hydrogen content in the tantalum powder during sintering, the tantalum powder still can impart effects on the resulting sintered products with respect to controlling the leakage current to a low value in a solid electrolyte capacitor including a sintered body of the tantalum powder. It is believed that hydrogen that is present at least in the vicinity of the surface of the high H/BET (>100) tantalum powder favorably affects the characteristics of the sintered body during the formation of the sintered body.

Even when the specific surface area of the tantalum powder of the present invention is large, the tantalum powder can be used to provide a solid electrolyte capacitor having a low leakage current or other enhanced performance. The BET specific surface area of the tantalum powder of the present invention can be in the range of from 3 to 20 m²/g, or from 4 to 20 m²/g, or from 5 to 20 m²/g, or from 7.5 to 20 m²/g, or from 10 to 20 m²/g, or from 3 to 10 m²/g, or from 4 to 10 m²/g, or from 5 to 10 m²/g, or from 3 to 8 m²/g, or from 4 to 8 m²/g, or from 3 to 6 m²/g, or from 3 to 5 m²/g, or other values. These BET specific surface areas can apply to the high H/BET (>100) hydrogen doped tantalum powders of the present invention after any stage of processing, such as after hydrogen doping, passivation, acid leaching and drying, sintering, or others. Other properties and characteristics of the finished high H/BET (>100) powders of the present invention are described herein.

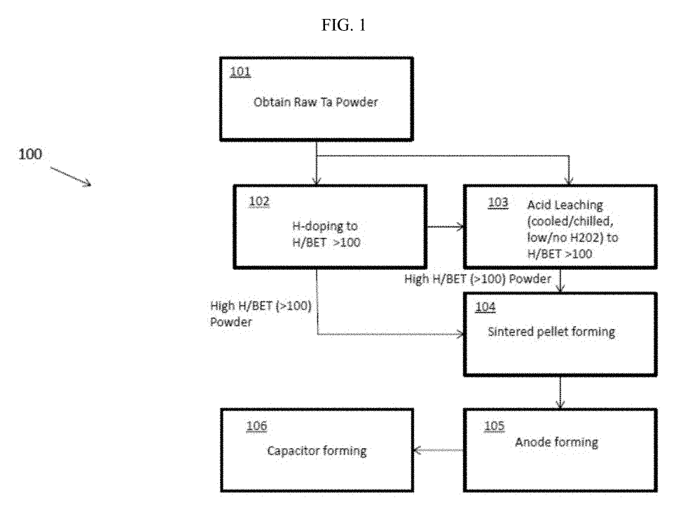

The high H/BET (>100) tantalum powders of the present invention can be prepared by a process including hydrogen doping applied alone or in combination with one or more other process steps as post-treatments applied to raw tantalum powder. Referring to FIG. 1, this drawing shows steps of a process of the present invention, identified by numeral 100, which has the indicated options for forming high H/BET (>100) tantalum powders from obtained raw tantalum powder (101) by hydrogen doping (102) and/or chilled low- or no peroxide acid leaching (103), and the resulting high H/BET powders can be sintered to form pellets (104), anodes (105), and capacitors (106). As will become apparent from further discussions herein, these steps can be used alone or as accompanied and complemented by additional process steps.

Raw tantalum powder (e.g., basic lot powder) can be obtained or produced by processes which are capable of providing powders having a surface area of at least 3 m²/g. Any tantalum powders can be used in this regard. Specific examples of the raw tantalum production process include sodium/halide flame encapsulation (SFE), a sodium reduction process of potassium fluorotantalate, a magnesium reduction process of a tantalum oxide, a gas-phase hydrogen reduction process of tantalum pentachloride, and a pulverizing process of tantalum metal. In the SFE process, vapor-phase sodium reacts with a gaseous metal halide, such as gaseous tantalum halide, to produce an aerosol core material and salt. Techniques employed for the SFE process which can be adapted for preparation of raw tantalum powder for the present invention are described in U.S. Pat. Nos. 5,498,446 and 7,442,227, which are incorporated in their entireties by reference herein. See, also, Barr, J. L. et al., “Processing salt-encapsulated tantalum nanoparticles for high purity, ultra high surface area applications,” J. Nanoparticle Res. (2006), 8:11-22. An example of the chemistry employed for the production of metal powder by the SFE process of the '446 patent is as follows, wherein “M” refers to a metal such as Ta: MClₓ+XNa+Inert→M+XNaCl+Inert. Tantalum pentachloride is an example of a tantalum halide that can be used as the reactant MClₓ, and argon gas may be used as the Inert and carrying gas, in this chemistry. Initially, core particles (e.g., Ta) are produced at the flame and grow by coagulation while the salt remains in the vapor phase. The salt condenses onto the core particles with heat loss, and uncoated core particles are scavenged by the salt particles as salt-encapsulated particles grow. The salt encapsulate allows for size and morphology control and can protect the core particles, such as from oxidation and/or hydrolysis, during storage and handling before use in capacitor grade powder production. The encapsulate can be removed in known manners, such as vacuum sublimation and/or a water wash, before use of the tantalum powders in capacitor grade powder production.

The tantalum fine powder (primary particles and secondary particles) alternatively can be obtained by the sodium reduction of tantalum salt, such as sodium tantalate fluoride in diluent salt, or other chemical or ingot processing methods.

The raw tantalum powder may comprise primary particles that have an average size in the range of 1 nm to about 500 nm, or 10 nm to 300 nm, or 15 nm to 175 nm, or 20 nm to 150 nm, or 25 nm to 100 nm, or 30 nm to 90 nm, or other sizes. The average size and distribution of the primary particles sizes can depend on the method of preparation. The primary particles may tend to form clusters or agglomerates of larger size than the primary particles. The shapes of raw powder particles may include, but are not limited to, flaked, angular, nodular, or spherical, and any combinations thereof or variations thereof. The raw powder used to practice the present invention can have any purity with respect to the tantalum metal with higher purities being preferred. For instance, the tantalum purity (e.g., by wt %) of the raw powder can be 95% Ta or greater, or 99% Ta or greater such as from about 99.5% Ta or greater and more preferably 99.95% Ta or greater and even more preferably 99.99% Ta or greater, or 99.995% Ta or greater or 99.999% Ta or greater.

A raw tantalum powder having a desired specific surface area can be produced by an above indicated production process or otherwise is obtained as indicated. The resulting tantalum powder can be subjected to at least one post-treatment such that the tantalum powder contains hydrogen adjusted to an amount that satisfies the above-described value or values to produce the high H/BET (>100) tantalum powder of the present invention.

The high H/BET (>100) tantalum powders of the present invention can be prepared using a hydrogen doping operation that is separate from and subsequent to the raw powder production operation.

Tantalum powder containing a predetermined amount of hydrogen can be produced by exposing the raw tantalum powder or an intermediate product obtained therefrom to hydrogen-containing gas under powder doping conditions. The tantalum powders do not have to be heated to very high temperatures during the hydrogen doping, and instead can be cooled from any high temperature condition applied before commencing hydrogen doping. The hydrogen-containing gas can be a gaseous mixture of hydrogen gas and an inert gas, such as noble gas such as argon, helium, or neon. The hydrogen content in the tantalum powder can be controlled by adjusting any one of: the gas composition that is supplied during the hydrogen doping treatment, temperature of the heat treatment, the time of the heat treatment, time of hydrogen treatment or by adjusting combinations of these parameters. The tantalum powder can be exposed to gas containing inert gas and 1-10 wt % hydrogen gas, or 1-7.5 wt % hydrogen gas, or 1-5 wt % hydrogen gas, or 2-4 wt % hydrogen gas, or other concentrations of hydrogen gas. The hydrogen doping treatment can be done in pure hydrogen. The temperature of the hydrogen doping treatment can be less than 350° C., less than 300° C., less than 200° C., less than 100° C., less 50° C., or less than 40° C., or less than 30° C., or from 20° C. to 40° C., or other temperatures. The duration of the hydrogen doping treatment can be in the range of 1 to 120 minutes, or 5 to 90 minutes, or 10 to 60 minutes, or other time periods.

The hydrogen doping of the tantalum powder can be performed in the same or different chamber in which the powder is processed in a preceding process step, such as deoxidation or other processing. The tantalum powder can be heated before the hydrogen doping step, such as to a temperature greater than 400° C. or other heated temperatures, and then is cooled or allowed to cool, such as to a temperature less than 50° C., or less than 40° C., or less than 30° C., or to a temperature of from 20° C. to 39° C., before starting any hydrogen doping of the powder. If the powder is deoxidized in a preceding process step, the powder typically is heated as part of that process step, and then is permitted to cool down or is cooled down by process means before commencing hydrogen doping of the deoxidized powder.

Hydrogen doping of the powder can be performed in one cycle or multiple cycles. The H/BET of finished powder of the present invention can be readily adjusted by changing the number of hydrogen doping cycles used in the hydrogen doping process developed for use in the present invention. A cycle of hydrogen doping can comprise backfilling a chamber containing the tantalum powder to a desired pressure level of the hydrogen-containing gas and holding the powder under the doping gas for period of time. At the conclusion of the holding period of the doping cycle, the doping gas can be exhausted from the process chamber by vacuum, though this is not required, and then the doped powder can be advanced to the next process step. Alternatively, the powder can be subjected to one or more additional hydrogen doping cycles in the same or a different process chamber. If multiple hydrogen doping cycles are used, the powder holding chamber again can be backfilled (after intervening vacuum or without intervening vacuum) to a desired pressure level of the hydrogen-containing gas, and the powder is held under the gas for period of time before optionally exhausting the gas by vacuum before any additional cycle(s) of hydrogen doping or otherwise advancing the doped powder to the next process operation to be performed on the powder. The hydrogen doping can be performed in 1 to 50 cycles, or from 2 to 10 cycles, or from 1 to 5 cycles, or from 2 to 5 cycles, or other numbers of cycles. As an example, 2 to 5 hydrogen doping cycles can be used with vacuum applied after each gas backfill for hydrogen doping and before any subsequent hydrogen doping cycle or different process operation (e.g., previous process operation→hydrogen doping→vacuum→hydrogen doping→vacuum→hydrogen doping→vacuum→next process operation). In multiple cycles of hydrogen doping, the chamber can be backfilled with the doping gas to the same gas pressure or a different gas pressures in different doping cycles. Incrementally smaller or greater gas pressures in successive doping cycles may be used. Gas pressure may be increased gradually or in a step-wise increase in successive doping cycles. Hydrogen-containing gas can be used for hydrogen doping operations that has the same composition (i.e., same H and inert gas concentrations) in each hydrogen doping cycle, or different gas compositions (i.e., different H and inert gas concentrations) can be used in two or more of the hydrogen doping cycles.

The hydrogen can be doped non-uniformly or uniformly in the tantalum powder. In this respect, the reference to “powder” can apply to a bulk layer or pile of powder particles, or to individual particles of powder, or both. The hydrogen can be doped in a greater concentration at or near an external surface than an interior of the tantalum powder. The hydrogen may be distributed in a gradient concentration of increasingly greater concentration towards the external surface of the powder. The hydrogen may be concentrated at or near the external surface of the powder wherein at least 50%, or at least 55%, or at least 60%, or at least 65%, or at least 70%, or at least 75%, or at least 80%, or at least 85%, or at least 90%, or at least 95%, or greater than 99%, or from 50% to 100%, or from 51% to 99%, or from 55% to 95%, of the total hydrogen content (by wt %) of the powder is located in a surface region of the powder. The surface region of the powder can be defined by a straight-line distance extending from the external surface of the powder towards the center of the powder that is less than 50%, or 25%, or 20%, or 15%, or 10%, or 5% of the total powder thickness or diameter of the powder layer or particles.

The tantalum powders of the present invention have hydrogen present as a dopant or otherwise present in sufficient amount to provide the high H/BET (>100) values. Hydrogen can be present in the tantalum powders as a crystalline form, solid solution form, or other form, or combinations of different forms. Hydrogen can be present in the tantalum powders as a crystalline form and/or solid solution form at any ratio. The hydrogen that can be present can be entirely in a crystalline form, or entirely in a solid solution form, or can be combinations thereof.

Hydrogen doping can be performed after deoxidation of tantalum powder with a getter agent (such as, e.g., magnesium deoxidation), and before powder passivation in air. At the end of deoxidation, such as performed in the presence of a getter agent at 300-1000° C. or 450-850° C. or other heated temperature, the powder can be cooled down or allowed to cool down to a much lower temperature (e.g., less than 50° C. or less than 40° C., or other lower temperature) in argon gas as indicated. Then, the process chamber can be pumped down to vacuum, and hydrogen-containing gas can be back filled to a specified pressure. After holding in hydrogen gas for a period of time, the chamber can once again be pumped to vacuum. Depending on the amount of hydrogen to be doped, this back fill of hydrogen step may take place multiple times. As an example, hydrogen doping can be carried out using a mixture of 2-3 wt % hydrogen (e.g., 2.5 wt % H) in argon as doping gas and by back filling to 725-775 torr (e.g., 750 torr) and holding for 5-15 minutes (e.g., 10 minutes) for each doping cycle. Experiment results disclosed herein show that H/BET of the finished powder can be readily adjusted by changing the number of doping cycles. After completing hydrogen doping, the powder can be subjected to one or more passivation cycles.

Tantalum powder can be passivated using an oxygen-containing gas, such as air, as part of the capacitor grade powder production process of the present invention. Passivation typically is used to form a stabilizing oxide film on the powder during processing and in advance of sintered body formation using the powder. A powder production process of the present invention therefore can include hydrogen doping and passivating operations. To integrate the hydrogen doping and passivating operations into the same process flow, the hydrogen doping can be performed before powder passivation, after powder passivation, or both. Some passivating can precede the hydrogen doping with care taken not to passivate too early or too much so as to form an oxide layer that would block subsequent hydrogen doping of the powder. More typically, at least some hydrogen doping of the tantalum powder material is performed before powder passivation is performed on the powder.

Passivation preferably is performed after the step of hydrogen doping. Passivation also can be achieved any time before, during, or after other powder processing steps such as heat treating, deoxidizing, nitriding, delubing, granulating, agglomerating, milling, and/or sintering of the powder, provided that any passivation conducted before the hydrogen doping is not performed too early or too extensively to block hydrogen doping when performed in a later step. In view of this, the tantalum powder may be passivated multiple times or only once, or never. Typically, the tantalum powder is passivated at least once during the process flow of producing finished powder.

Passivating the tantalum powder can be by any suitable method. Passivation can be achieved in any suitable container, for example, in a retort, a furnace, a vacuum chamber, or a vacuum furnace. Passivation can be achieved in any of the equipment used in processing, such as heat treating, deoxidizing, nitriding, delubing, granulating, milling, and/or sintering, the metal powder. The passivating of the metal powder can be achieved under vacuum. Passivation can include backfilling of the container with an oxygen containing gas to a specified gas pressure, and holding the gas in the container for a specified time. The oxygen content level of the gas used in powder passivation can be from 1 to 100 wt % oxygen, or from 1 to 90 wt %, or from 1 to 75 wt %, or from 1 to 50 wt %, or from 1 to 30 wt %, or from 20 to 30 wt %, or an oxygen content that is the same as or greater than that of air or atmospheric air, or other content levels. The oxygen can be used in combination with an inert gas, such as nitrogen, argon, or combinations of these, or other inert gases. The inert gas does not react with the tantalum during the passivation process. The inert gas, such as nitrogen gas and/or argon gas, preferably can compose all or essentially all (e.g., >98%) of the remaining portion of the passivating gas other than the oxygen. Air can be used as the passivating gas. Air can refer to atmospheric air or dry air. The composition of dry air typically is nitrogen (about 75.5 wt %), oxygen (about 23.2 wt %), argon (about 1.3 wt %), and the rest in a total amount of less than about 0.05%. The content level of hydrogen in dry air is about 0.00005 vol %.

Passivation can be achieved by a step-wise or cyclic increase in operating pressure in the container, a gradual increase in operating pressure, or a combination thereof (venting). Cyclic passivation can include venting and evacuation of the container. For purposes of the present invention, a cycle of passivation can include increasing the operating pressure in the container in which the tantalum powder is contained by a predetermined amount, and maintaining or holding the increased container pressure for a predetermined amount of time, a complete cycle comprising venting/holding. Optionally, another cycle can then be initiated by a further increase in operating pressure. For purposes of the present invention, a cycle of passivation can also include increasing the operating pressure of the passivation container by a predetermined amount, and maintaining the increased container pressure for a predetermined time, followed by an evacuation of the passivation container or decreasing the operating pressure by a predetermined amount, a complete cycle comprising venting/holding/evacuation. Optionally, a subsequent passivation cycle can then be initiated by a further venting of the passivation container.

Preferably, passivation is achieved in an environment in which the tantalum powder is stabilized by at least partially surface passivating a plurality of the particles of the powder in the fewest number of passivation cycles and/or in the least amount of passivation time as possible. In the present invention, passivating of the hydrogen-doped powder can be more than 60 cycles, 60 cycles or less, 25 cycles or less, or 10 cycles or less, or 5 cycles or less of passivation. As indicated, passivation of the tantalum powders can be completed with less passivation cycles in the processing of the high H/BET (>100) powders of the present invention. As indicated, reduced passivation cycles can also assist acid leaching in providing acid leached powders having high H/BET (>100) values. Passivation can include a fewer or a greater number of cycles than described above, sufficient to form a passivated powder. The number of cycles needed to form a passivated powder can relate to the specific surface area, form, shape, type, and/or amount, and the like of the powder, as well as to passivation pressures, temperatures, hold times, equipment, and/or passivating gas concentrations and the like. A passivation cycle can be any amount of time, for example, from about 1 to about 30 minutes or more. Total passivation time can depend on any or all of the aforementioned parameters, and can be for a time of from about 15 to about 600 minutes or more, for instance. The number of passivation cycles and overall passivation time can be reduced in the present invention.

Passivation can be at any temperature that allows formation of a passive surface coating on the particles of the powder. For example, the temperature within the passivation container can be from about 20° C. to about 90° C. The temperature within the passivation container can be held constant during passivation or can be increased or decreased during any single passivation cycle, at certain stages, and/or during the entire passivation process. The passivation temperature within the container can depend on the prior, concurrent, or subsequent processing steps performed on the powder. The hold times can be the same or different for multiple-cycle passivation. Other actions can be taken that affect the formation of a passive coating on the powder particles such as movement of the passivation container and/or agitation of the tantalum, tantalum oxide, and/or tantalum suboxide powder during passivation.

The passivation container can have any starting pressure prior to passivation, and as an option, the passivation container can be under vacuum, for example, from about 0.1 torr to about 1 torr, or other values. Passivation of the powder can be initiated by cyclic exposure to progressively higher partial pressures of gas that contains oxygen. For example, the pressure in the passivation container can be increased by an amount of from about 5 torr to about 100 torr, and such as, from about 10 torr to about 25 torr, or other pressures, by backfilling the passivation container with the oxygen-containing gas. The hold time can be sufficient to allow at least some of the oxygen present in the gas to react with the powder so as to at least partially surface passivate at least some of the particles. The hold time may be from about 1 minute to about 10 minutes, or other times. This can constitute a passivation cycle. Alternatively, the passivation cycle can further include at least one evacuation step. The step of evacuating the passivation container can be sufficient to remove some, most, or all of any residual inert gas(es) present in the powder. Evacuating the passivation container can be achieved by reducing the pressure to a value of 0.1 torr to about 50 torr, or other values. The container can be evacuated to a pressure that is less than the initial pressure in the container, or can be evacuated to a pressure that is equal to or greater than the initial operating pressure. Upon achieving the desired vacuum pressure in the passivation container, the container can then be pressurized to a predetermined operating pressure by backfilling the container with a predetermined amount of gas, for example, from about 5 torr to about 100 torn which gas includes oxygen and/or inert gas(es). The oxygen content of the gas that is backfilled can be the same or different in successive passivation cycles.

As an example of an integrated scheme for using passivation and hydrogen doping, and other process steps, the hydrogen doping process can be performed after powder deoxidation and before powder passivation. The hydrogen doping and passivating can be performed completely in sequence (e.g., previous process operation (e.g., deoxidation)→1 or more cycles of hydrogen doping→1 or more cycles of passivating→next process operation) or alternatively, in alternating sequence (e.g., previous process operation (e.g., deoxidation)→hydrogen doping cycle→passivating cycle→hydrogen doping cycle→passivating cycle→and so on→next process operation).

Additional techniques that may be employed for the passivation process can be adapted from those disclosed in U.S. Pat. No. 7,803,235, which is incorporated in its entirety by reference herein.

Prior to the hydrogen doping and passivation such as discussed above, the raw powder can be subjected to one or more preliminary treatments. When produced by a chemical method such as those indicated above, the above raw tantalum powders can be recovered as dried powder, and then agglomerated, crushed or milled, classified, and/or other process steps. In this regard, the preliminary steps of manufacturing the high H/BET (>100) tantalum powder can comprise an aggregation process for obtaining agglomerate powder, e.g., by heat treatment (thermal aggregation of tantalum raw powder); an optional preliminary crushing process for crushing the agglomerate powder in advance; a pulverization process for pulverizing the agglomerate powder, either obtained from the preliminary crushing process or pulverization process; and a recovery process for recovering powder of a given diameter range by sifting or other classifying of the pulverized powder obtained from the pulverization process. These processes are explained, for example, in more detail in U.S. Pat. No. 8,657,915, which is incorporated in its entirety by reference herein. If thermally aggregated, the process can be performed by heating tantalum raw powder in a furnace. In addition, the tantalum raw powder may be treated by preliminary aggregation in advance, and may also be a granulated powder obtained by granulating with water as a binder, such as described in U.S. Pat. No. 6,479,012, which is incorporated in its entirety by reference herein.

As an example of preliminary treatments that can be used before hydrogen doping, the tantalum powder can be water agglomerated, then dried, and classified to recover a −200 mesh size (0.074 mm nominal sieve opening) fraction or other fraction thereof, and then deoxidized, all prior to the hydrogen doping.

Because of the oxygen concentration of the tantalum material, the raw powder, or intermediate powder obtained from the raw powder by water and/or thermal agglomeration and crushing, can be deoxidized at temperatures in the presence of a getter material that has a higher affinity for oxygen than the tantalum metal. The deoxidation step can be used any number of times and can be used before the hydrogen doping described above. If a magnesium deoxidation is used, as an example, from 1 wt % to 30 wt % magnesium, e.g., 1-5 wt %, or 1-10 wt %, or 10-25 wt % magnesium or other amounts, by total weight of tantalum can be used during the magnesium deoxidation step and the temperature at which this magnesium deoxidation step occurs can be at a temperature of up to 1200° C., and such as from about 300° C. to about 1000° C., or from about 450° C. to about 850° C., or other temperatures. As an example, 0-10 wt % or 0-5 wt % magnesium powder or other amounts of magnesium powder (by total weight of tantalum) can be added prior to a subsequent acid leach. The magnesium deoxidation can be accomplished in an inert atmosphere, such as argon. The magnesium deoxidation can be generally for a sufficient time and at a sufficient temperature to remove at least a significant portion of the oxygen in the tantalum powder. The length of time for the magnesium deoxidation can be from 20 minutes to 3 hours, or from 30 minutes to 60 minutes, or other durations. The magnesium that is used generally vaporizes and precipitates out, e.g. as MgO₂, for instance, on a cold wall of the furnace in this magnesium deoxidation step. Any remaining magnesium and/or magnesium oxide can be substantially removed by a subsequent process, such as acid leaching. Additional details on these preliminary treatments are in U.S. Pat. No. 5,993,513, which is incorporated in its entirety by reference herein.

The hydrogen-doped tantalum powder of the present invention can include other dopants, such as nitrogen dopant. Nitrogen in the amounts used, e.g., from 500 ppm to 3,500 ppm, is desirous since it can lead to increased capacitance of the final anode and better controlling of electrical leakage (for instance, by making a less dense pressed/sintered anode). The nitrogen can be added to the tantalum powder at one or more points during the process. The nitrogen dopant can be introduced into the tantalum powder, as an example, at any time or times between steps 101 and 105 in FIG. 1 that can accommodate such processing. For example, the nitrogen dopant may be added during any heat cycle after the powder is pressed into pellets, but before the pellets are anodized, such as by adding gaseous nitrogen after agglomeration, or by adding nitrogen in a deoxidation cycle before pressing the powder into pellets, or by adding nitrogen during the reduction stage that forms tantalum or using combinations of these additions or other nitrogen additions. The tantalum powder can be doped during powder production with nitrogen using methods adapted from those described, such as in U.S. Pat. No. 5,448,447 and WO 01/59166 A1, which are incorporated in their entireties by reference herein.

The hydrogen doped powder can be acid leached to remove contaminants, including magnesium and magnesium oxide, before the material is used to produce capacitors. As indicated, the powder which is deoxidized with a getter material can be acid leached in a subsequent process step. In the present invention, when acid leaching is used, it can occur after the powder already has been deoxidized, hydrogen doped, and passivated. The acid leaching can be performed using a strong mineral acid solution including, for example, nitric acid, hydrofluoric acid, nitric acid, sulfuric acid, hydrochloric acid, or combinations of these or other acids, at controlled temperature conditions, to dissolve any metal and metal oxide contaminants. Nitric acid can be used in the leach solution. The acid leach solution can contain small or no amounts of hydrogen peroxide. The acid leach solution can contain less than 10% (w/v), or less than 5% (w/v), or less than 1% (w/v), or less than 500 ppm, or from 1%-10% (w/v), or from 1%-5% (w/v), or from 0-1% (w/v), or 0-100 ppm hydrogen peroxide.

Elevated temperatures (above room temperature to about 100° C.) can be used during the post-deoxidation acid leach to increase the activity of the acid solution in dissolving any residual metal and metal oxide contaminants, such as magnesium and magnesium oxide, on the valve metal material. As described in U.S. Pat. Nos. 6,312,642 and 5,993,519, which are incorporated in their entireties by reference herein, the high temperature post-deoxidation acid leach also can etch the valve metal particles and increase their surface area, thereby resulting in an undesirable increase in oxygen concentration upon subsequent exposure to the atmosphere. The acid leach process of the present invention can be performed on the tantalum powders at temperatures lower than 70° C., or 60° C., or 50° C., or 40° C., or 30° C., or room temperature (e.g., 10-25° C. or 20-25° C.), or 10° C., or from 10° C. to 70° C., or from 20° C. to 60° C., or from 20° C. to 50° C., or lower temperatures such as from −5° C. to 10° C. or −1° C. to −5° C. or other temperatures, to minimize undesirable effects of the acid leaching on the particle. Acid leach solutions at temperatures substantially below room temperature are most effective to remove residual metal and metal oxide contaminants while controlling the resulting oxygen concentration of the valve metal materials. The acid leach solution temperature can be below about 25° C.; such as below about 0° C. The acid solution, the tantalum metal material, and/or the acid leaching container may be precooled, and/or ice may be added to the acid leach solution after the solution has been added to a leach container. The acid leach solution can be cooled using ice/salt bath techniques known to those skilled in the art. For example, a cold leach solution (e.g., −5° C. to −1° C.) can be prepared by cooling 20-25% HNO₃ solution in an ice/salt bath. The chemical reactions during acid leaching can be exothermic. In the cases of the present examples (described below), the acid leach temperature can be defined as the temperature of the acid leaching solution prior to the addition of the deoxidized valve metal material. After completion of the acid leaching, the acid leached powder typically can then be washed and dried before further processing as finished powder.

As used herein, “finished powder” refers to powder that has received all hydrogen doping process steps and any other process steps applied to the raw tantalum powders before sintering the powders into a porous body form. These finished powders can have the high H/BET (>100) values indicated above. The hydrogen content of the tantalum powders of the present invention can be from about 300 ppm to about 1200 ppm, or from 300 ppm to 1100 ppm, or from 300 ppm to 1000 ppm, or from 300 ppm to 950 ppm, or from 300 ppm to 900 ppm, or from 300 ppm to 800 ppm, or from 300 ppm to 750 ppm, or from 400 ppm to 1100 ppm, or from 400 ppm to 1000 ppm, or from 400 ppm to 750 ppm, or from 500 ppm to 1000 ppm, or other values of hydrogen content.

Nitrogen content of the tantalum powders (e.g., “finished powders”) of the present invention can be from about 500 ppm to about 3500 ppm, or from 500 ppm to 3000 ppm, or from 500 ppm to 2500 ppm, or from 500 ppm to 2000 ppm, or from 500 ppm to 1500 ppm, or from 750 ppm to 3500 ppm, or from 750 ppm to 2500 ppm, or from 750 ppm to 2000 ppm, or from 750 ppm to 1500 ppm, or from 1000 ppm to 3500 ppm, or from 1000 ppm to 3000 ppm, or other values of nitrogen content.

The oxygen content of the tantalum powders (e.g., finished powders) can be from about 1,000 ppm to about 60,000 ppm, such as from 2,500 ppm to 50,000 ppm, or from 8,000 ppm to 30,000 ppm, or from 9,000 ppm to 25,000, or from 10,000 ppm to 20,000 ppm, or other values of oxygen content.

An oxygen (in ppm) to BET (in m²/g) ratio of the tantalum powders (e.g., finished powders) can be from about 2,000 to about 4,000, such as from 2,200 to 3,800, or from 2,400 to 3,600, or from 2,600 to 3,400, or from 2,800 to 3,200, or other ratio values.

The purity (% tantalum) of the finished powder can fall in any one of the ranges of purity indicated for the raw powder.

The tantalum powder of the present invention, as an example, can have a surface area, hydrogen content, and nitrogen content, which combines any of these values for these respective characteristics as indicated here in any combination.

The finished high H/BET (>100) tantalum powder of the present invention can be in the form of primary particles, or secondary particles formed by aggregated (or agglomerated) primary particles, or in the form of tertiary particles formed by further aggregating (or agglomerating) secondary particles, or combinations of any of these forms. For the finished tantalum powder of the present invention, the diameter of all or substantially all particles/agglomerates can fall in a range of from 1-200 μm, or from 45-75 μm, or from 45-55 μm, or other values. Wherein, the term “substantially all” refers to preferably 95 wt % or more, such as 95 wt % to 99.9 wt %, or 97 wt % to 99.5 wt %, or 98 wt % to 99 wt % by total weight of the tantalum powder. The powder can have a unimodal, bimodal, or multi-modal, and/or polydispersed distribution. Regarding the grain distribution (or particle size distribution) of primary particles of tantalum powder, a distribution can be obtained in which 80% or more of the particles (based on total number of primary particles) fall within ±5 nm to ±100 nm of the average particle size. A distribution in which 80% or more of the primary particles fall within ±5 nm of the average particle size can be obtained. The particle size distribution can be less than 80% with respect to primary particles falling within ±5 nm of the average grain size. The particle size distribution can be wherein 85% to 99% or more, or from 90% to 99% or more, or from 95% to 99% or more of the tantalum powder can be within ±5 nm of the average grain size. For purposes of the present invention, the various percent ranges provided for the particle size distribution can apply to primary particles that fall within ±10 nm or +7 nm.

Further, the finished tantalum powder can have desirable flow rates. For instance, the flow rates of the finished tantalum powders of the present invention can have a flow rate of from about 30 seconds to about 3 minutes, wherein the test involves the time it takes for 20 grams of tantalum powder to pass through an orifice of 0.1 inch. The flow rates can be from about 45 seconds to about 2½ minutes, from about 60 seconds to about 2 minutes, from about 60 seconds to about 1½ minutes, as well as other flow rates. The powders can have a Scott density or an apparent density for tantalum of from about 15 g/in³ to about 40 g/in³, or other values. The powders can have a tap density of from about 10% to about 90% of theoretical density, or other values. The powders can have other properties above and below the numerical values described above.

The resultant hydrogen-doped tantalum powder product, sometimes referred to herein as a “finished powder,” may be compressed and sintered to make porous bodies, such as anodes for capacitors. The finished powder is capacitor grade powder.

The anode for the solid electrolytic capacitor of the present invention is a porous sintered body that can be obtained by sintering the above mentioned tantalum powder.

The temperature for sintering the tantalum powder can be from about 1,000° C. to about 1,700° C., preferably 1,000° C.-1,400° C. Sintering time can be about 0.1 hour to about 2 hours or more, preferably 0.25 hour to 1 hour. In addition, when sintering, a lead wire may be embedded in the tantalum powder.

The finished powder can be compressed to form a pellet, sintered to form a porous body, and anodized in a suitable electrolyte to form a continuous dielectric oxide film on the sintered body. The finished powder can be formed into a pellet with or without temporary binder that is eliminated during sintering. Temporary binder, if used, can be used in an amount of about 1 wt % to 10 wt % or other amounts, can be added to the tantalum powder prepared above and sufficiently mixed therewith. Subsequently, a 0.4 mm to 4 mm or other sized diameter pellet can be prepared by a press molding, which can use any typical press molding equipment and techniques used for this purpose. The tantalum powder can be formed into pellets using a press density of from 1 g/cm³ to 10 g/cm³ or other values. Preferred examples of the temporary binder, if used, include camphor, stearic acid, polyvinyl alcohol, naphthalene, singly or in combinations or other binder materials. As indicated, valve metal lead wires, such as tantalum wire, can be embedded in the powder and any binder before sintering. The pellet can be sintered by heating in a vacuum of a furnace pressure, such as of 0.001 Pa or lower, at the indicated sintering temperatures and times. In such manner, a porous tantalum sintered body can be prepared. The sintered pellet has holes (or passageways or pores) sufficiently sized for a conductive polymer-containing solution to pass through.

The hydrogen content of the sintered pellet can be below 500 ppm, below 400 ppm, below 300 ppm, below 200 ppm, below 100 ppm, or below 50 ppm, or below 10 ppm, or 1 ppm or lower, or from 1 ppm to 500 ppm, or from 1 ppm to 400 ppm, or from 1 ppm to 300 ppm, or from 1 ppm to 200 ppm, or from 1 ppm to 50 ppm, or 1 ppm to 10 ppm, or from 10 ppm to 100 ppm, or from 10 ppm to 50 ppm, or other values. Accordingly, the hydrogen content of finished powder as compared to the hydrogen content of the powder in the sintered pellet or other body, can be reduced (by volume or by wt %) 50% or more, or 60% or more, or 70% or more, or 80% or more, or 85% or more, or 90% or more, or 95% or more, or 99% or more, or from 50% to 100%, or from 50% to 99%, or from 50% to 95%, or other reduction amounts. The oxygen content and BET values of the powder in the sintered pellet or other body can be the same or substantially the same (e.g., within ±5%, or other values) as the respective values indicated for the finished powder.

The sintered body, e.g., sintered pellet, may be deoxidized with magnesium and acid leached in a process similar to the powder treatment prior to being anodized. The resulting tantalum sintered body typically is subjected to anodic oxidation to form an oxide film on the surface of the sintered body, thereby preparing an anode. In the anodic oxidation, for example, a 0.05 vol % to 2 vol % solution of phosphoric acid can be used at a temperature of 55-65° C., or other temperatures, and the voltage can be 5 V to 15 V at a current density of 75 μA/g to 125 μA/g, and the anodic oxidation can be performed under this condition for 1 hour to 3 hours, or other values. The hydrogen content of the tantalum in the anode can be below 500 ppm, or below 250 ppm, or below 100 ppm, or below 50 ppm, or below 10 ppm, or 1 ppm or lower, or from 1 ppm to 500 ppm, or from 1 ppm to 250 ppm, or from 1 ppm to 100 ppm, or from 1 ppm to 50 ppm, or from 1 ppm to 10 ppm, or from 10 ppm to 500 ppm, or from 50 ppm to 500 ppm, or from 100 ppm to 500 ppm, or from 10 ppm to 250 ppm, or from 50 ppm to 250 ppm, or other values.

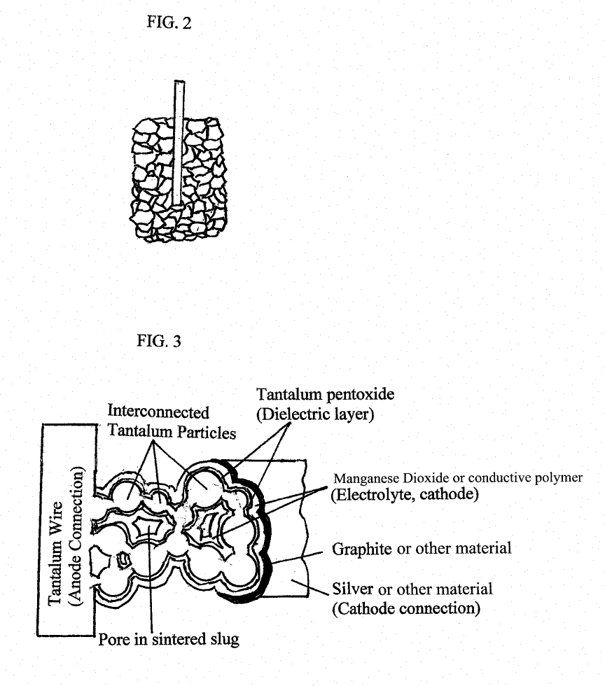

FIG. 2 is a schematical representation of a pellet formed of sintered tantalum powder of the present invention which can be made using the finished powder by the above process steps or others.

A capacitor anode can be formed with the powders of the present invention by any method, for example, as described in U.S. Pat. Nos. 8,657,915, 6,527,937 B2; 6,462,934 B2; 6,420,043 B1; 6,375,704 B1; 6,338,816 B1; 6,322,912 B1; 6,616,623; 6,051,044; 5,580,367; 5,448,447; 5,412,533; 5,306,462; 5,245,514; 5,217,526; 5,211,741; 4,805,704; and 4,940,490, all of which are incorporated herein in their entireties by reference.

The anode porosity (sintered anode) can be characterized by pore size distribution that is unimodal or multi-modal, and preferably can be unimodal with more than 90%, or more than 95%, or more than 99%, or 100% (by volume) of pores having pore size of less than 150 nm, or from 1 nm to 1000 nm (e.g., from 1 nm to 149 nm, or from 1 nm to 1000 nm, or from 10 nm to 1000 nm, or from 50 nm to 1000 nm, or from 100 nm to 1000 nm) and a peak pore size in the range of from 40 nm to 150 nm, or from 50 nm to 90 nm, or from 60 nm to 70 nm, or other values. The anodes can have low embrittlement, such as determined from passing standard manual wire bending tests (e.g., 10 bending times).

Anodes made with the hydrogen doped metal powders of the present invention can have a capacitance (CV) of at least 150,000 μF-V/g, or at least 175,000 μF-V/g, or at least 200,000 μF-V/g, or at least 225,000 μF-V/g, or at least 250,000 μF-V/g, or from 150,000 to 800,000 μF-V/g, or from 150,000 to 500,000 μF-V/g, or 150,000 to 485,000 μF-V/g, or from 150,000 to 470,000 μF-V/g, or from 150,000 to 450,000 μF-V/g, or from 200,000 to 800,000 μF-V/g, or from 200,000 to 500,000 μF-V/g, or 200,000 to 450,000 μF-V/g or other capacitance values.

Anodes made with the hydrogen doped metal powders of the present invention can have a leakage current of 650 μA/g or less, or 600 μA/g or less, or 550 μA/g or less, or 500 μA/g or less, or from 0 to 650 μA/g, or from 10 to 600 μA/g, or from 50 to 500 μA/g, or other values.

The anodes can have a leakage current (LC/CV) that is less than 10 nA/μFV, or 6 nA/μFV or less, or less than 5 nA/μFV, or less than 4 nA/μFV, or less than 3 nA/μFV, or less than 2 nA/μFV, or less than 1 nA/μFV, or from or from 0.1 to 10 nA/μFV, or from 0.1 to 7.5 nA/μFV, or from 0.1 to 6.0 nA/μFV, or from 0.5 to 6.0 nA/μFV, or from 0.5 to 5.0 nA/μFV, or from 0.1 to 5.0 nA/μFV, or from 0.5 to 4.0 nA/μFV, or from 0.5 to 2.5 nA/μFV, or other values. These capacitance and leakage values can also apply to sintered pellets of the present invention.

Regarding the measuring method of CV and leakage current values in the present invention, first, tantalum pellets are produced. The pellets have tantalum lead wires present. The tantalum powder is formed into pellets using a press density of 4.5 g/cm³ to 5.5 g/cm³. In order to obtain this density, only the mass and pellet shape of the tantalum powder need to be defined. It is preferable to select the sintering temperature of the pellets arbitrarily such that the shrinkage ratio of the tantalum powder remains in a range of 5 to 10%. The sintering temperature is preferably in a range of from 1,100° C. to 1,250° C. Next, chemically converted substances are produced by chemically converting the pellets in a phosphoric acid aqueous solution of concentration 0.1 vol. % at a voltage of 6 V to 10 V. For the chemical conversion, in order to form a uniform (or substantially uniform) oxide film on the surface of tantalum powder, it is preferable to make an adjustment within a range when necessary, and formation conditions are the following: 30° C. to 60° C. for temperature, 4 V to 20 V for voltage, and 90 minutes to 120 minutes for the treatment time. The CV values of the chemically converted substances are measured in a 30.5 (vol.) % sulfuric acid aqueous solution under the conditions: temperature 25° C., frequency 120 Hz, and voltage 1.5 V. Direct leakage current (DLC) is measured as the current value after 3 minutes under conditions of a voltage of 7 V in a 10 vol. % aqueous phosphoric acid solution at 25° C. Also, any individual value within the ranges for capacitance and leakage current can be used for purposes of the present invention.

Further, the sintered pellets and anodes of the present invention can have capacitance and/or leakage current properties which are comparable to or better than pellets and anodes made with more production intensive steps that use large numbers of passivation cycles and hydrogen peroxide in acid leach process steps. In this respect, the sintered pellets and anodes of the present invention can comprise a porous body which has at least one of (i) a capacitance voltage that is at least 5%, or at least 10%, or at least 15%, or at least 20%, or at least 25%, or from 5% to 25%, or from 5% to 20%, or from 10% to 25% or other values, greater than a capacitance (CV) for a sintered pellet made in the same manner except using 60 cycles of passivation in the passivating and 10% (w/v) hydrogen peroxide in the acid leach solution in the leaching during powder making, (ii) a leakage current (LC) that is at least 5%, or 10%, or 20%, or 25%, or from 5% to 25%, or from 5% to 20%, or from 10% to 25% or other values, less than a leakage current for a sintered pellet made in the same manner except using 60 cycles of passivation in the passivating and 10% (w/v) hydrogen peroxide in the acid leach solution in the leaching during powder making.

Subsequently, a solid electrolyte capacitor comprising the anode can be manufactured. A counterelectrode (cathode) forming material can be applied, such as in the form of a conductive polymer, on the tantalum anode. For electrical access to the cathode, a graphite layer and a conductive metal layer, such as a silver layer, contacting the cathode may be applied. The resulting structure can be embedded in a non-conductive material, such as a non-conductive resin (e.g., polypyrrole or polythiophene), to provide the capacitor. Outer terminals can be connected to the anode and the conductive metal layer contacting the cathode material, such as in any suitable method. The entire structure can be covered with a resin to obtain a solid electrolyte capacitor.

The hydrogen content of the tantalum derived from the tantalum powder in the electrolytic capacitor can be below 500 ppm, or below 250 ppm, or below 100 ppm, or below 50 ppm, or below 10 ppm, or 1 ppm or lower, or from 1 ppm to 500 ppm, or from 1 ppm to 250 ppm, or from 1 ppm to 100 ppm, or from 1 ppm to 50 ppm, or from 1 ppm to 10 ppm, or from 10 ppm to 500 ppm, or from 50 ppm to 500 ppm, or from 100 ppm to 500 ppm, or from 10 ppm to 250 ppm, or from 50 ppm to 250 ppm, or other values.

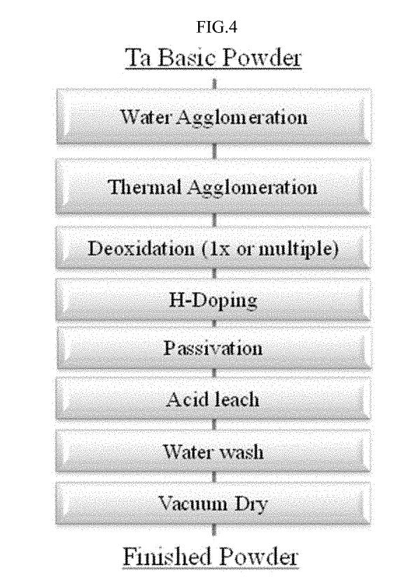

FIG. 3 is a schematical representation of the structure of a sintered tantalum electrolytic capacitor with solid electrolyte and the cathode contacting layers of the present invention which can be made by the above process steps or others.

The present invention will be further clarified by the following examples, which are intended to be exemplary of the present invention.

### EXAMPLES

### Example 1

Laboratory scale and scale-up experiments were performed to study the effect of hydrogen doping and the number of hydrogen doping cycles on deoxidized tantalum powder.

For these experiments, the finished tantalum powder was obtained by a process flow similar to that shown in FIG. 4. The raw tantalum powder obtained by sodium/halide flame encapsulation (SFE) was agglomerated and screened/classified to obtain the −200 mesh fraction 90 g (lab scale) or 750 g (scale-up) of the tantalum powder was deoxidized at 650° C. for 450 minutes. Hydrogen doping was performed in 2.5 wt % hydrogen and argon gas for multiple cycles, or no cycles in the reference example, and under other conditions indicated in this example. The hydrogen doped powder was then passivated in 20 wt % oxygen and argon gas for 60 cycles at 20 to 30° C. for 60 minutes. 90-400 g portions of passivated powder was acid leached with solution containing 150-200 mL HNO₃ and 550-1650 g deionized H₂O iced to −0° C. No hydrogen peroxide was included in the acid leach solution for these experiments. The acid treated powder was water washed (e.g., 8-12 L deionized water at 50-60° C.), and vacuum dried again at 80° C. for 12 hours. The acid leach step shown in the process flow shown in FIG. 4 may be performed with different kinds of acid solutions and treatment temperatures, which may or may not include hydrogen peroxide. Further, one or more of the process steps shown in the process flow in FIG. 4 may be omitted other than the hydrogen doping step. As shown, hydrogen doping was performed after magnesium deoxidation and before powder passivation. At the end of magnesium deoxidation, the powder was cooled down to a temperature of less than 40° C. in argon gas. Then, the chamber was pumped down to vacuum, and hydrogen-containing gas was back filled to a specified pressure. After holding in hydrogen gas at the pressure for a specified time, the chamber was once again pumped to vacuum. Depending on the amount of hydrogen to be doped, this step of backfilling hydrogen was performed multiple times. After completing hydrogen doping, the powder received multiple passivation cycles.

More specifically, experiments were carried out using a mixture of 2.5 wt % hydrogen in argon as doping gas and by back filling to 750 torr and holding for 10 minutes for each doping cycle. The H doping and H/BET results for these experiments are shown in Tables 1-2.

TABLE 1
H-doping lab-scale (90 g Ta) experiment results

| | # of H-doping | H | BET | H/BET |
|---|---|---|---|---|
| Sample run# | cycles | (ppm) | (m²/g) | (ppm/(m²/g)) |
| Control | 0 | 417 | 5.1 | 82 |
| B-Run-1 | 24 | 1180 | 4.9 | 242 |
| B-Run-2 | 12 | 801 | 4.9 | 165 |
| B-Run-3 | 9 | 700 | 4.7 | 148 |
| B-Run-4 | 9 | 659 | 4.7 | 140 |
| B-Run-5 | 9 | 702 | 4.8 | 147 |

TABLE 2
H-doping scale-up experiment results (750 g Ta)

| | # of H-doping | H | BET | H/BET |
|---|---|---|---|---|
| Sample run # | Cycles | (ppm) | (m²/g) | (ppm/(m²/g)) |
| C-Run-1 | 10 | 1690 | 7.1 | 239 |
| C-Run-2 | 5 | 686 | 5.2 | 130 |
| Ref. | 0 | 399 | 5.0 | 80 |

The testing results in Tables 1-2 show that the H/BET value of finished powder can be readily adjusted by changing the number of hydrogen doping cycles.

Chemical and physical properties of the finished powder from the scale-up experiments are shown in Tables 3A-B and electrical properties of sintered pellets formed with the powder are shown in Table 4. Sintered pellets with an embedded wire were formed from the finished powder. The measurement conditions used for these experiments were the following:

Pellet: weight=0.05 g, (I) (diam.)=2.0 mm, press density=5.5 g/cm³,
Sintering: T=1190° C., 1240° C., 180 minutes,
Formation: 0.1 vol % H₃PO₄, T=60° C., 20 minutes,
CV measurement: 30.5 vol % H₂SO₄, T=25° C., f=120 Hz, Bias=1.5 V,
LC measurement: 10 vol % H₃PO₄, T=25° C., t=3 minutes, V=7 V.

TABLE 3A
Powder chemical and physical properties

| | # of H- | | | | | | | | | | | | |
|---|---|---|---|---|---|---|---|---|---|---|---|---|---|
| Sample | Doping | O | N | H | C | Fe | Ni | Cr | Si | N | K | Mg | P |
| Run# | cycles | ppm | Ppm | ppm | Ppm | ppm | ppm | ppm | ppm | ppm | ppm | Ppm | ppm |
| C-Run-2 | 5 | 12640 | 1490 | 686 | 79 | 8 | <5 | 7 | 6 | 3 | 3 | 73 | 270 |
| Ref. | 0 | 13980 | 1600 | 399 | 61 | 13 | 5 | 13 | 7 | 3 | 1 | 33 | 302 |

TABLE 3B
Powder chemical and physical properties

| Sample | | BET | H/BET | O/BET |
|---|---|---|---|---|
| Run# | SN | m²/g | (ppm/(m²/g)) | (ppm/(m²/g)) |
| C-Run-2 | 30.7 | 5.28 | 130 | 2394 |
| Ref. | 30.7 | 4.99 | 80 | 2802 |

TABLE 4
Electrical testing results of samples

| | | | | | | | | | | Wire |
|---|---|---|---|---|---|---|---|---|---|---|
| | # of H- | | | | | LC | | | | Bend |
| Sample | Doping | | | CV/g (μFV/g) | | (nA/μFV) | | Ds/Dg | | 10 |
| Run# | cycles | BET | H/BET | ST(C) = 1190 | 1240 | 1190 | 1240 | 1190 | 1240 | times |
| C-Run-2 | 5 | 5.2 | 130 | 262800 | 215100 | 5.45 | 5.91 | 1.00 | 1.15 | pass |
| Ref. | 0 | 5.0 | 80 | 254800 | 211400 | 7.04 | 7.32 | 1.01 | 1.15 | pass |

ST(C) = sinter temperature in ° C.
Ds = sintered density
Dg = green density
Wire Bend = manual bend test

When compared to a H/BET of below 100, such as below 90, Table 3A-B and Table 4 show that there is 22% reduction in direct current leakage (DCL) with no significant effect of H (in H/BET>100 powder) on powder physical, chemical, and other electrical properties The process also has the following advantages (a) less powder passivation cycles (52%), therefore, lower manufacturing cost, (b) lower oxygen in powder when ice is used in acid leach, which, according to the publication on J. Electrochem. Soc., Vol. 156, 2009 pp. G65-G70, leads to less flaw sites in anodic oxide film, therefore, higher reliability of capacitors.

### Example 2

Additional experiments were conducted to compare the leakage current of anodes formed with hydrogen doped tantalum according to the present invention with anodes made with low hydrogen containing tantalum. The results show that higher hydrogen doped tantalum powder shows 10% lower leakage current (LC) than low hydrogen containing powder (with a H/BET below 100). It should be noted that low hydrogen amounts in tantalum can occur inherently in many cases as shown here. However, to obtain H/BET ratio above 100, generally doping with hydrogen is needed.

The testing procedure was generally as indicated in FIG. 4 with modifications as described below:

1) Conduct deoxidation process.

2) After deoxidation finishes, keep vacuuming and wait until temperature of furnace decreases below 33° C.

3) Stop vacuuming and check that pressure in furnace is below: 0.12 kPa.

4) Back fill 3 vol % hydrogen—Argon to furnace until pressure in furnace reach to P kPa. (P is below atmosphere pressure).

5) Hold 10 minutes.

6) Vacuum until pressure in furnace becomes below 0.12 kPa.

7) Repeat 4)-6) X times.

8) Vacuum until pressure in furnace becomes below 0.03 kPa.

9) Conduct passivation, acid leaching and water wash.

Hydrogen amount is controllable by changing pressure in 4) (P) and cycle time in 7) (X).

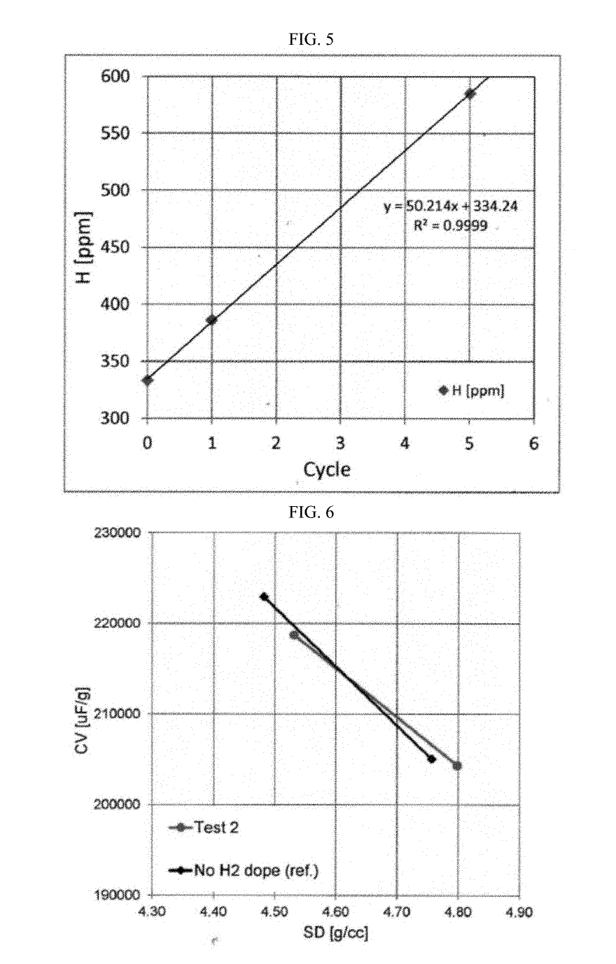

Table 5 and FIG. 5 show results of the hydrogen doping test. A low hydrogen containing sample was made without the hydrogen doping step 4) as a reference (“Ref.”). Hydrogen amount in tantalum powder increases lineally with increasing cycle time.

TABLE 5
Result of hydrogen doping test

| Sample | | Pressure | | O | N | H | BET | H/BET |
|---|---|---|---|---|---|---|---|---|
| Run# | Gas | (kPa) | Cycle | (ppm) | (ppm) | (ppm) | (m²/g) | (ppm/(m²/g)) |
| Ref. | Ar | 92.0 | 5 | 9020 | 1060 | 333 | 4.27 | 78 |
| Test 1 | 3 vol % H₂ + Ar | 91.7 | 1 | 9020 | 1120 | 386 | 4.21 | 92 |
| (comp.) | | | | | | | | |
| Test 2 | 3 vol % H₂ + Ar | 91.7 | 5 | 9020 | 1050 | 585 | 4.32 | 135 |

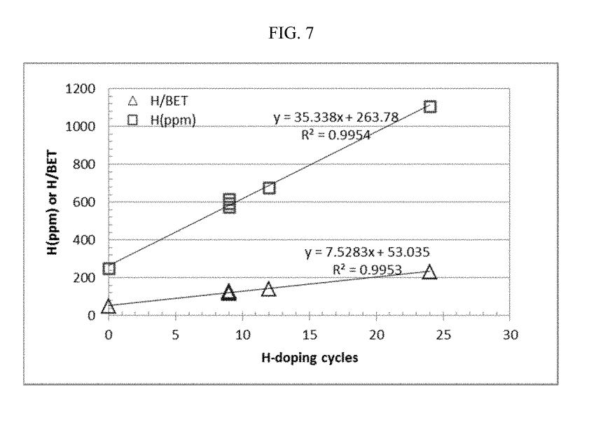

Table 6 and FIG. 6 show electrical properties of the powders produced in this hydrogen doping study. In Test 2, the sample shows about 10% lower LC than the reference powder.

TABLE 6
Electrical properties of hydrogen doping test

| Sintering | | | |
|---|---|---|---|
| Temp. (° C.) | Property | Test 2 | Ref. |
| 1150 | CV (uFV/g) | 218730 | 222930 |
| | LC (uA/g) | 1012 | 1128 |
| | Tan δ (%) | 184 | 189 |
| | SD (g/cc) | 4.53 | 4.48 |
| 1200 | CV/(uFV/g) | 204340 | 205030 |
| | LC (uA/g) | 848 | 946 |
| | Tan δ (%) | 177 | 177 |
| | SD (g/cc) | 4.80 | 4.76 |

The measurement conditions used for these experiments were the following:

Pellet: weight=0.05 g, φ (diam.)=2.0 mm, gravimetric density (GD)=5.5 g/cm³,
Sintering: T=1150° C., 1200° C., 20 minutes,
Formation: 0.1 vol % H₃PO₄, T=60° C., 120 minutes,
CV measurement: 30.5 vol % H₂SO₄, T=25° C., f=120 Hz, Bias=1.5 V,
LC measurement: 10 vol % H₃PO₄, T=25° C., t=3 minutes, V=7 V.

The results of these experiments show that the higher hydrogen doped tantalum powder shows 10% lower LC in sintered pellets than low hydrogen containing powder. The results also show that use of a single hydrogen doping cycle may not provide sufficient H doping to provide an H/BET value of greater than 100, as indicated by the results for comparison Test 1.

### Example 3

An acid leach test was conducted on hydrogen doped powders, which had been doped and processed in a similar manner as the preceding example (Example 1). The acid solution was composed of a mixture of nitric acid with and without hydrogen peroxide. The acid solution was poured into a test container and the temperature of the acid solution was controlled to a temperature of 0° C. to 5° C. The hydrogen doped powder was immersed in the acid solution and held in the acid solution for 35 minutes. The tantalum powder then was washed and dried, and analyzed. Test conditions of these acid leach tests are shown in Table 7. As indicated, tests were conducted as follows: Test-1 is standard condition using full amount of H₂O₂; Test-2 is acid leaching without H₂O₂. The acid leach was performed in two stages of addition of chemicals to the powder in acid leach solutions.

TABLE 7
Test conditions

| | | | PW | H₂O₂ | HNO₃ | H₂O₂ | HNO₃ |
|---|---|---|---|---|---|---|---|
| Test | H₂O₂ % | Ta (g) | (ml) | (ml) | (ml) | (ml) | (ml) |
| 1 (Ref.) | 100 | 100 | 200 | 25 | 50 | 25 | 50 |
| 2 | 50 | 100 | 200 | 13 | 50 | 13 | 50 |
| 3 | 0 | 100 | 200 | 0 | 50 | 0 | 50 |

The resulting etched powders were dried and analyzed for doping composition, surface area, density, and also electrical properties of the sintered pellets based thereon with the results shown in Tables 8A-B. SD is sintered density and Tan 6 is dissipation factor.

TABLE 8A
Test results - powder chemical and physical properties

| | H₂O₂ | O | N | H | BET | H/BET |
|---|---|---|---|---|---|---|
| Test | (ml) | (ppm) | (ppm) | (ppm) | (m²/g) | (ppm/(m²/g)) |
| 1 | 100 | 13250 | 1570 | 557 | 5.40 | 103 |
| 2 | 0 | 12640 | 1490 | 686 | 5.28 | 130 |

TABLE 8B
Test results - electrical properties (at ST = 1240 C.)

| Sample | CV/g | LC | LC/CV | Tan δ | SD |
|---|---|---|---|---|---|
| Run# | (μFV/g) | (μA/g) | (nA/μFV) | (%) | (g/cc) |
| 1 | 212100 | 1370 | 6.46 | 126 | 6.39 |
| 2 | 215100 | 1271 | 5.91 | 125 | 6.30 |

As shown in the testing results in Tables 8A-B leakage current (LC) became 9% lower when H₂O₂ was not used in the acid leach solution and the concentration of hydrogen increased 23%.

### Example 4

Scale-up experiments were performed in a similar manner with procedures described in Example 2 using nine (9) hydrogen doping cycles and samples acid leached with ice and no H₂O₂ to study the repeatability of effect of hydrogen doping and the number of hydrogen doping cycles on deoxidized tantalum powder. The test results are shown in Table 9.

TABLE 9

| Sample | # of | O | N | H | C | BET | H/ |
|---|---|---|---|---|---|---|---|
| ID | H-doping cycles | ppm | ppm | Ppm | ppm | m²/g | BET |
| R-1 | 9 | 15523 | 1143 | 594 | 43 | 4.81 | 124 |
| R-2 | 9 | 15647 | 1119 | 573 | 24 | 4.81 | 119 |
| R-3 | 9 | 14600 | 1073 | 614 | 63 | 4.81 | 128 |

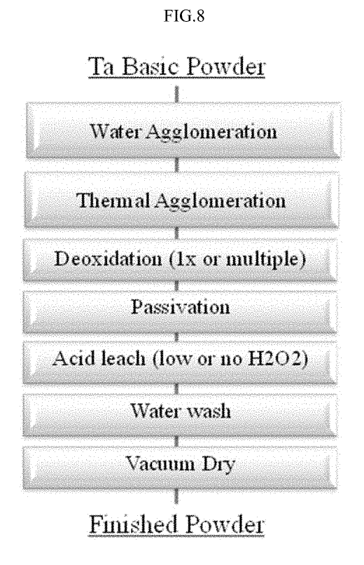

As shown by the results in Table 9, the H/BET values for all three runs were in the range of 119 to 128. FIG. 7 shows a plot of testing results for H and H/BET with respect to the number of H-doping cycles. These results further show that the level of hydrogen doping and H/BET can be controlled by the number of hydrogen doping cycles used.

### Example 5

Additional small sample tests were conducted to study the influence of using different concentrations of hydrogen peroxide (100%, 50%, 0%) in iced acid leaching solution on hydrogen content, oxygen content, BET, and H/BET of the finished tantalum powder. A procedure similar to the process flow shown in FIG. 8 was used with variations in the acid leach treatment as indicated herein. The acid leach was performed in two stages of immersion of the powder in acid leach solutions. The results are shown in Tables 10 and 11.

TABLE 10

| | | | | | 1st | 1st | 2nd | 2nd | | | | |
|---|---|---|---|---|---|---|---|---|---|---|---|---|
| | | Ta | DI | Ice | H2O2 | HNO3 | H2O2 | HNO3 | | | | |
| | | (g) | (ml) | (g) | (ml) | (ml) | (ml) | (ml) | Oxygen | Hydrogen | BET | H/BET |
| test | H2O2 | 100 | 200 | 0 | 25.0 | 50.0 | 25.0 | 50.0 | 9280 | 296 | 4.35 | 68 |
| 1-1 | 100% | | | | | | | | | | | |
| test | H2O2 | 100 | 200 | 0 | 12.5 | 50.0 | 12.5 | 50.0 | 9240 | 303 | 4.36 | 69 |
| 1-2 | 50% | | | | | | | | | | | |
| test | H2O2 | 100 | 200 | 0 | 0.0 | 50.0 | 0.0 | 50.0 | 10290 | 544 | 4.52 | 120 |
| 1-3 | 0% | | | | | | | | | | | |
| test | H2O2 | 100 | 200 | 20 | 25.0 | 50.0 | 25.0 | 50.0 | 9090 | 281 | 4.26 | 66 |
| 1-4 | 100% + ice | | | | | | | | | | | |
| test | H2O2 | 100 | 200 | 20 | 0.0 | 50.0 | 0.0 | 50.0 | 10660 | 552 | 4.64 | 119 |
| 1-5 | 0% + ice | | | | | | | | | | | |

TABLE 11

| | | SD | | | Tan δ | | | | pellet | wire |
|---|---|---|---|---|---|---|---|---|---|---|
| | | (g/cc) | CV (uFV/g) | LC (uA/g) | (%) | GS (n = 3) | pellet O | pellet H | BET | bending |
| test | H2O2 | 4.73 | 205200 | 730 | 179.0 | 4.0 | 12740 | 137 | 2.98 | over 10 |
| 1-1 | 100% | | | | | | | | | |
| test | H2O2 | 4.72 | 204600 | 707 | 178.3 | 3.6 | 13230 | 154 | 2.96 | over 10 |
| 1-2 | 50% | | | | | | | | | |
| test | H2O2 | 4.73 | 202000 | 623 | 176.0 | 3.9 | 13070 | 142 | 2.91 | over 10 |
| 1-3 | 0% | | | | | | | | | |
| test | H2O2 | 4.73 | 203400 | 709 | 177.3 | 3.9 | 12490 | 126 | 2.96 | over 10 |
| 1-4 | 100% + ice | | | | | | | | | |
| test | H2O2 | 4.74 | 201100 | 634 | 175.7 | 3.6 | 12460 | 162 | 2.89 | over 10 |
| 1-5 | 0% + ice | | | | | | | | | |

The testing results in Tables 10 and 11 show that hydrogen peroxide concentration in the acid leaching solution influenced hydrogen, oxygen, BET, and H/BET. In Table 11, the 0% H2O2 condition sample shows about 10% lower LC than the H2O2 using condition powder in 1200C ST. There also was no apparent difference in oxygen and BET after sintering.

The present invention includes the following aspects/embodiments/features in any order and/or in any combination:

1. The present invention relates to a tantalum powder comprising tantalum and hydrogen doped therein and nitrogen doped therein, wherein a value of hydrogen (H) content (ppm) of the tantalum powder divided by Brunauer-Emmett-Teller (BET) surface area (m²/g) of the tantalum powder (H/BET) is greater than 100, wherein the tantalum powder has (a) a hydrogen content of from 300 ppm to 1200 ppm, (b) a nitrogen content of from 500 ppm to 3,500 ppm, and (c) a BET range of from 3 m²/g to about 10 m²/g.
2. The tantalum powder of any preceding or following embodiment/feature/aspect, wherein the tantalum powder, when formed into an anode has a capacitance (CV) of at least 150,000 μF-V/g and a leakage current of 6 nA/μFV or less.
3. The tantalum powder of any preceding or following embodiment/feature/aspect, wherein the H/BET value is from 105 to 135.
4. The tantalum powder of any preceding or following embodiment/feature/aspect, wherein the H/BET value is from 110 to 135.
5. The tantalum powder of any preceding or following embodiment/feature/aspect, wherein the H/BET value is from 120 to 135.
6. The tantalum powder of any preceding or following embodiment/feature/aspect, wherein the H/BET value is from 125 to 250.
7. The tantalum powder of any preceding or following embodiment/feature/aspect, wherein the hydrogen content is from 400 ppm to 650 ppm.
8. The tantalum powder of any preceding or following embodiment/feature/aspect, wherein the hydrogen content is from 500 ppm to 600 ppm.
9. The tantalum powder of any preceding or following embodiment/feature/aspect, wherein the BET surface area of the tantalum powder is in a range of from 4 m²/g to 10 m²/g.
10. The tantalum powder of any preceding or following embodiment/feature/aspect, wherein the BET surface area of the tantalum powder is in a range of from 5 m²/g to 10 m²/g.
11. The present invention further relates to a sintered pellet comprising the tantalum powder of any preceding or following embodiment/feature/aspect, wherein the sintered pellet has a capacitance (CV) of from 150,000 μF-V/g to 500,000 g-V/g, and a leakage current of 6 nA/μFV or less.
12. The sintered pellet of any preceding or following embodiment/feature/aspect, wherein the hydrogen content of the tantalum powder is below 100 ppm.
13. The sintered pellet of any preceding or following embodiment/feature/aspect, wherein the hydrogen content of the tantalum powder is below 50 ppm.
14. The sintered pellet of any preceding or following embodiment/feature/aspect, wherein the hydrogen content of the tantalum powder is below 1 ppm.
15. The present invention further relates to an anode for a capacitor comprising the tantalum powder of any preceding or following embodiment/feature/aspect.
16. The anode of any preceding or following embodiment/feature/aspect, wherein the hydrogen content of the tantalum powder is below 500 ppm.
17. The anode of any preceding or following embodiment/feature/aspect, wherein the hydrogen content of the tantalum powder is below 50 ppm.
18. The anode of any preceding or following embodiment/feature/aspect, wherein the hydrogen content of the tantalum powder is below 1 ppm.
19. The present invention further relates to an electrolytic capacitor comprising the anode of any preceding or following embodiment/feature/aspect.
20. The electrolytic capacitor of any preceding or following embodiment/feature/aspect, wherein the hydrogen content of the tantalum powder is below 500 ppm.
21. The electrolytic capacitor of any preceding or following embodiment/feature/aspect, wherein the hydrogen content of the tantalum powder is below 50 ppm.
22. The electrolytic capacitor of any preceding or following embodiment/feature/aspect, wherein the hydrogen content of the tantalum powder is below 1 ppm.
23. The present invention further relates to a method of making the tantalum powder according to any preceding or following embodiment/feature/aspect, comprising:

hydrogen doping tantalum powder to provide hydrogen-doped tantalum powder; and

passivating the hydrogen-doped tantalum powder in the presence of gas comprising oxygen to provide passivated hydrogen-doped tantalum powder.

24. The method of any preceding or following embodiment/feature/aspect, further comprising deoxidizing the tantalum powder prior to the hydrogen doping.
25. The method of any preceding or following embodiment/feature/aspect, wherein the hydrogen doping comprises from 1 to 10 cycles of hydrogen doping.
26. The method of any preceding or following embodiment/feature/aspect, wherein the hydrogen doping comprises from 1 to 5 cycles of hydrogen doping.
27. The method of any preceding or following embodiment/feature/aspect, wherein the hydrogen doping comprises multiple cycles of hydrogen doping.
28. The method of any preceding or following embodiment/feature/aspect, further comprising applying a vacuum after at least one of the multiple cycles of the hydrogen doping.
29. The method of any preceding or following embodiment/feature/aspect, wherein the hydrogen doping comprises exposing the tantalum powder to gas containing inert gas and 1-10 wt % hydrogen gas.
30. The method of any preceding or following embodiment/feature/aspect, further comprising performing multiple cycles of the passivating after completion of multiple cycles of the hydrogen doping.
31. The method of any preceding or following embodiment/feature/aspect, further comprising performing alternating cycles of the hydrogen doping and the passivating more than once.
32. The method of any preceding or following embodiment/feature/aspect, wherein the passivating comprises 60 cycles or less of passivation.
33. The method of any preceding or following embodiment/feature/aspect, wherein the passivating comprises 30 cycles or less of passivation.
34. The method of any preceding or following embodiment/feature/aspect, wherein the passivating comprises 20 cycles or less of passivation.
35. The method of any preceding or following embodiment/feature/aspect, wherein a cycle of passivation comprises introducing of a passivating gas comprising inert gas and 1-30 wt % oxygen into a container that contains the hydrogen doped tantalum powder to increase the operating pressure in the container by a predetermined amount, and maintaining or holding the increased operating pressure in the container for a predetermined amount of time, followed by evacuating at least a portion of the passivating gas from the container.
36. The present invention further relates to a method of making the tantalum powder according to any preceding or following embodiment/feature/aspect, comprising:

leaching tantalum powder in an acid leach solution to provide acid leached tantalum powder having a hydrogen doping or level; and

washing and drying the acid leached tantalum powder to provide dried tantalum powder with a hydrogen content.

37. The method of any preceding or following embodiment/feature/aspect, further comprising deoxidizing the tantalum powder prior to the leaching.
38. The method of any preceding or following embodiment/feature/aspect, wherein the leaching of the passivated tantalum powder is performed with the acid leach solution at a temperature of 70° C. or less to remove getter material contaminants present from the deoxidizing, wherein the acid leach solution contains from 0% to 10% (w/v) hydrogen peroxide.
39. The method of any preceding or following embodiment/feature/aspect, wherein the acid leach solution contains less than 5% (w/v) hydrogen peroxide.
40. The method of any preceding or following embodiment/feature/aspect, wherein the acid leach solution contains 0-1% (w/v) hydrogen peroxide.
41. The method of any preceding or following embodiment/feature/aspect, wherein 0 to 5% magnesium powder is added prior to the acid leach.
42. The method of any preceding or following embodiment/feature/aspect, further comprising hydrogen doping and passivating the tantalum powder prior to the leaching.
43. The method of any preceding or following embodiment/feature/aspect, further comprising deoxidizing, hydrogen doping, and passivating the tantalum powder prior to the leaching.
44. The method of any preceding or following embodiment/feature/aspect, wherein the passivating performed prior to the leaching comprises 35 cycles or less of passivation.
45. The method of any preceding or following embodiment/feature/aspect, wherein a cycle of passivation comprises introducing of a passivating gas comprising inert gas and from 1 wt % to 30 wt % oxygen into a container that contains the deoxidized tantalum powder to increase the operating pressure in the container by a predetermined amount, and maintaining or holding the increased operating pressure in the container for a predetermined amount of time, followed by evacuating at least a portion of the passivating gas from the container.
46. The method of any preceding or following embodiment/feature/aspect, further comprising producing raw tantalum powder prior to the hydrogen doping by sodium/halide flame encapsulation (SFE), and the tantalum powder used in the hydrogen doping is the raw tantalum powder or a tantalum powder derived therefrom.
47. The method of any preceding or following embodiment/feature/aspect, further comprising agglomerating tantalum powder prior to the hydrogen doping to provide agglomerated tantalum powder, and the tantalum powder used in the hydrogen doping is the agglomerated tantalum powder or a tantalum powder derived therefrom.
48. The method of any preceding or following embodiment/feature/aspect, wherein the deoxidizing is performed at a temperature of from 450° C. to 1000° C. in the presence of a getter material that has a higher affinity for oxygen than the tantalum powder.
49. The present invention further relates to a method of making a sintered pellet, comprising the steps of:

compressing the dried tantalum powder made by the method of any preceding or following embodiment/feature/aspect to form a pellet;

sintering the pellet to form a porous body, wherein the porous body has a capacitance (CV) of from 150,000 μF-V/g to 500,000 μF-V/g, and a leakage current of 6 nA/μFV or less.

50. The present invention further relates to a method of making a sintered pellet, comprising the steps of:

compressing the dried tantalum powder made by the method of any preceding or following embodiment/feature/aspect to form a pellet;

sintering the pellet to form a porous body, wherein the porous body has at least one of:
(i) a capacitance voltage that is at least 5% greater than a capacitance (CV) for a sintered pellet made in the same manner except using 60 cycles of passivation in the passivating and 10% (w/v) hydrogen peroxide in the acid leach solution in the leaching during powder making,
(ii) a leakage current (LC) that is at least 5% less than a leakage current for a sintered pellet made in the same manner except using 60 cycles of passivation in the passivating and 10% (w/v) hydrogen peroxide in the acid leach solution in the leaching during powder making.
   51. The present invention further relates to a method of making a capacitor anode, comprising:

heat treating the porous body made by the method of any preceding or following embodiment/feature/aspect in the presence of a getter material to form an electrode body, and

anodizing the electrode body in an electrolyte to form a dielectric oxide film on the electrode body to form a capacitor anode.

The present invention can include any combination of these various features or embodiments above and/or below as set forth in sentences and/or paragraphs. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A tantalum powder comprising tantalum and hydrogen doped therein and nitrogen doped therein, wherein a value of hydrogen (H) content (ppm) of the tantalum powder divided by Brunauer-Emmett-Teller (BET) surface area (m²/g) of the tantalum powder (H/BET) is greater than 100, wherein the tantalum powder has (a) a hydrogen content of from 300 ppm to 1200 ppm, (b) a nitrogen content of from 500 ppm to 3,500 ppm, and (c) a BET range of from 3 m²/g to about 10 m²/g.

2. The tantalum powder of claim 1, wherein said tantalum powder, when formed into an anode has a capacitance (CV) of at least 150,000 μF-V/g and a leakage current of 6 nA/μFV or less.

3. The tantalum powder of claim 1, wherein the H/BET value is from 105 to 135.

4. The tantalum powder of claim 1, wherein the H/BET value is from 110 to 135.

5. (canceled)

6. The tantalum powder of claim 1, wherein the H/BET value is from 125 to 250.

7. The tantalum powder of claim 1, wherein the hydrogen content is from 400 ppm to 650 ppm.

8. (canceled)

9. The tantalum powder of claim 1, wherein the BET surface area of the tantalum powder is in a range of from 4 m²/g to 10 m²/g.

10. (canceled)

11. A sintered pellet comprising the tantalum powder of claim 1, wherein the sintered pellet has a capacitance (CV) of from 150,000 μF-V/g to 500,000 μF-V/g, and a leakage current of 6 nA/μFV or less.

12. The sintered pellet of claim 11, wherein the hydrogen content of the tantalum powder is below 100 ppm.

13. (canceled)

14. The sintered pellet of claim 11, wherein the hydrogen content of the tantalum powder is below 1 ppm.

15. An anode for a capacitor comprising the tantalum powder according to claim 1.

16. The anode of claim 15, wherein the hydrogen content of the tantalum powder is below 500 ppm.

17. (canceled)

18. The anode of claim 15, wherein the hydrogen content of the tantalum powder is below 1 ppm.

19. An electrolytic capacitor comprising the anode of claim 15.

20-22. (canceled)

23. A method of making the tantalum powder according to claim 1, comprising:
hydrogen doping tantalum powder to provide hydrogen-doped tantalum powder; and
passivating the hydrogen-doped tantalum powder in the presence of gas comprising oxygen to provide passivated hydrogen-doped tantalum powder.

24. The method of claim 23, further comprising deoxidizing the tantalum powder prior to the hydrogen doping.

25-26. (canceled)

27. The method of claim 23, wherein the hydrogen doping comprises multiple cycles of hydrogen doping.

28. The method of claim 27, further comprising applying a vacuum after at least one of the multiple cycles of the hydrogen doping.

29. (canceled)

30. The method of claim 23, further comprising performing multiple cycles of the passivating after completion of multiple cycles of the hydrogen doping.

31. (canceled)

32. The method of claim 23, wherein the passivating comprises 60 cycles or less of passivation.

33-34. (canceled)

35. The method of claim 32, wherein a cycle of passivation comprises introducing of a passivating gas comprising inert gas and 1-30 wt % oxygen into a container that contains the hydrogen doped tantalum powder to increase the operating pressure in the container by a predetermined amount, and maintaining or holding the increased operating pressure in the container for a predetermined amount of time, followed by evacuating at least a portion of the passivating gas from the container.

36. A method of making the tantalum powder according to claim 1, comprising:
leaching tantalum powder in an acid leach solution to provide acid leached tantalum powder having a hydrogen level; and
washing and drying the acid leached tantalum powder to provide dried tantalum powder with a hydrogen content.

37. The method of claim 36, further comprising deoxidizing the tantalum powder prior to the leaching.

38. The method of claim 37, wherein the leaching of the passivated tantalum powder is performed with the acid leach solution at a temperature of 70° C. or less to remove getter material contaminants present from the deoxidizing, wherein the acid leach solution contains from 0% to 10% (w/v) hydrogen peroxide.

39. The method of claim 36, wherein the acid leach solution contains less than 5% (w/v) hydrogen peroxide.

40. The method of claim 36, wherein the acid leach solution contains 0-1% (w/v) hydrogen peroxide.

41. The method of claim 38, wherein 0 to 5% magnesium powder is added prior to the acid leach.

42. The method of claim 40, further comprising hydrogen doping and passivating the tantalum powder prior to the leaching.

43. The method of claim 36, further comprising deoxidizing, hydrogen doping, and passivating the tantalum powder prior to the leaching.

44. (canceled)

45. The method of claim 44, wherein a cycle of passivation comprises introducing of a passivating gas comprising inert gas and from 1 wt % to 30 wt % oxygen into a container that contains the deoxidized tantalum powder to increase the operating pressure in the container by a predetermined amount, and maintaining or holding the increased operating pressure in the container for a predetermined amount of time, followed by evacuating at least a portion of the passivating gas from the container.

46-48. (canceled)

49. A method of making a sintered pellet, comprising the steps of:
compressing the dried tantalum powder made by the method of claim 25 to form a pellet;
sintering the pellet to form a porous body, wherein the porous body has a capacitance (CV) of from 150,000 μF-V/g to 500,000 μF-V/g, and a leakage current of 6 nA/μFV or less.

50. A method of making a sintered pellet, comprising the steps of:
compressing the dried tantalum powder made by the method of claim 43 to form a pellet;
sintering the pellet to form a porous body, wherein the porous body has at least one of:
(i) a capacitance voltage that is at least 5% greater than a capacitance (CV) for a sintered pellet made in the same manner except using 60 cycles of passivation in the passivating and 10% (w/v) hydrogen peroxide in the acid leach solution in the leaching during powder making,
(ii) a leakage current (LC) that is at least 5% less than a leakage current for a sintered pellet made in the same manner except using 60 cycles of passivation in the passivating and 10% (w/v) hydrogen peroxide in the acid leach solution in the leaching during powder making.

51. A method of making a capacitor anode, comprising:
heat treating the porous body made by the method of claim 50 in the presence of a getter material to form an electrode body, and
anodizing the electrode body in an electrolyte to form a dielectric oxide film on the electrode body to form a capacitor anode.
